(19) United States
(12) Patent Application Publication
(10) Pub. No.: US 2020/0148062 A1
(43) Pub. Date: May 14, 2020

(54) CUSTOMIZATION OF AN ELEMENT FOR CONTROLLING A VEHICLE FUNCTION

(71) Applicant: NOVARES France, CLAMART (FR)

(72) Inventor: François BOLLIER, NICE (FR)

(21) Appl. No.: 16/632,038

(22) PCT Filed: Jul. 20, 2018
(86) PCT No.: PCT/FR2018/051853

§ 371 Date: Jan. 17, 2020

(30) Foreign Application Priority Data
Jul. 21, 2017 (FR) 17/56971

(51) Int. Cl. B60K 37/06

(52) U.S. Cl. CPC B60K 37/06; B60R 2011/0063; B60K 2370/122

(57) ABSTRACT

The invention relates to a method for customising an element for the passive control of a function of a vehicle, characterised in that it involves: a step of non-definitively fixing a passive control element in an active fixing zone of said vehicle, said active fixing zone being electronically connected to a control unit; and a step of defining a function associated with the control element.

### CROSS REFERENCE TO RELATED APPLICATIONS

This application is a National Stage of PCT Application No. PCT/FR2018/051853 filed on Jul. 20, 2018, which claims priority to French Patent Application No. 17/56971 filed on Jul. 21, 2017, the contents each of which are incorporated herein by reference thereto.

### TECHNICAL FIELD

The invention concerns the field of vehicles and more particularly the customization of an element for controlling a vehicle function.

### BACKGROUND

A function of an automobile is defined as a specific operation or activity. An automobile has, in addition to its main function which is to run, many secondary functions such as for example «take an instant photo using the cameras of the passenger compartment», another secondary function can be «play an audio CD», or else «display the position of the vehicle on the GPS screen».

The functions of the automobile, just like the design of the bodywork and the ergonomics of the passenger compartment, participate in making the automobile an object with which users identify. Thus, the functions offered by an automobile participate in attracting customers for one automobile rather than another.

Currently, there are many elements for controlling a function such as a protruding part thereafter called button, a touch screen, a voice control or gesture control.

The disadvantage raised by controls made by means of buttons is the need to define, during the design of the passenger compartment, the positioning of said buttons. As a result, the control buttons, which are generally provided to be used by the driver, are difficult to access to a passenger. Thus, the ergonomics of the vehicle cannot be adapted to the use by several occupants. As an illustration, a large family will want some controls to be accessible from the passenger seats which will not be the case of a single driver.

The controls performed on a touch screen are customizable on the surface of the touch screen. However, a location of said touch screen has been determined during the design of the passenger compartment. In addition, the location of the touch screen is limited by mechanical and safety constraints. Indeed, a touch screen has a certain rigidity limiting the possible locations in the passenger compartment and can injure the occupants of the automobile in case of accident. Finally, the cost of touch screens does not allow placing, within the passenger compartment, a large number thereof.

Voice and gesture controls do not have a specific positioning in the passenger compartment space but require complex setting and electronic equipment. In addition, the control allowing the activation of the voice or gesture control is generally performed by a button whose positioning is determined in the design.

There is known the document DE102014218506 that describes a method allowing to customize an element for controlling a function of a vehicle in which a control element is positioned on a passive fastening area, a headphone system positioned on the head of the driver allows determining the position of the control element and activating the associated function.

There is also known document DE102010010574 disclosing a method allowing to freely position a rotary control element assigned to a function of the vehicle, in which the active control element is positioned on an active fastening area. When the user desires to modify the function associated with the control element, he must position a new control element associated with the desired function.

### BRIEF SUMMARY

The invention has the purpose of overcoming all or part of the aforementioned disadvantages by providing a passive control element of a vehicle function whose location in the passenger compartment is customizable.

The invention relates to a method for customizing a passive control element of a vehicle function, characterized in that it implements:
a step of non-permanently fastening a passive control element in an active fastening area of said vehicle, in electronic connection with a control unit;
a step of defining a function associated with the repositionable control element.

Thus, a location of a control element is no longer determined in the design of the vehicle but by the occupant. The occupant of the vehicle may, at any time, fasten a new control element of a vehicle function after delivering said vehicle over the entire fastening area. The control element is not permanently fastened, that is to say, it can be removed or displaced. The control element is positioned on the fastening area at the location desired by the occupant depending on various parameters such as his habits or body type. The customization of a control element consists in the choice of the location and the function of the control element.

According to one characteristic of the invention, the method for customizing a passive control element of a vehicle function, includes a step of modifying the function associated with the passive control element.

Thus, the occupant can modify the function of a passive control element depending on the evolution of his habits or his use of the vehicle. The same control element, positioned at the same location, may control a different function from that previously defined.

According to one characteristic of the invention, the method for customizing a passive control element of a vehicle function, includes a step of repositioning said passive control element.

Thus, the occupant can modify the location of a passive control element depending on the evolution of his habits or his use of the vehicle. The control element is then repositionable. The same control element associated with the same function will be fastened on a different location from the fastening area. The control element can also be removed or displaced if the occupant so desires.

The invention also consists in a device allowing the implementation of a method for customizing a passive control element of a vehicle function according to any one of the preceding claims, comprising at least one control unit and at least one passive control element, characterized in that it further comprises at least one active fastening area in electronic connection with the at least one control unit.

Thus, the fastening area allows fastening at least one physical control element over its entire surface then defining a function associated with this control element thanks to the electronic connection with the control unit.

According to one characteristic of the invention, the device comprises a plurality of fastening areas.

According to one characteristic of the invention, the at least one active fastening area comprises a printed capacitive film.

Thus, the electronic connection is made with the control unit by a capacitive film.

The fastening area is then a touch area whose particular location is defined as a control element. In this case, the control element is an object without a particular technology, that is to say that the control element is a passive, inert or neutral object, allowing to locate a specific location of the fastening area. An object of the control element is only to designate a particular location of the fastening area. The control element does not comprise any particular technology.

According to one characteristic of the invention, a fastening area is in direct connection with the control unit.

According to one characteristic of the invention, the capacitive film is disposed on a face of a trim panel.

Thus, the trim panel becomes the fastening area.

According to one characteristic of the invention, the capacitive film is disposed on a face of a trim panel, said face being intended to be invisible to an occupant.

Thus, the aesthetics of the trim panel is preserved.

According to one characteristic of the invention, the capacitive film is positioned by overmolding on the trim panel.

Thus, the manufacture of the trim panel does not require performing an additional action.

According to one characteristic of the invention, the capacitive film is added onto the trim panel after molding.

According to a characteristic of the invention, the control element is fastened in a repositionable manner.

Thus, the control element can be repositioned if the occupant of the automobile so desires, that is to say that the location of the element can be changed on the fastening area. The control element can also be removed from the control area if the occupant of the automobile so desires.

According to one characteristic of the invention, the control element is fastened by means of an adhesive.

According to one characteristic of the invention, the control element is magnetized on the fastening area.

Thus, the control element is easily repositionable.

According to one characteristic of the invention, the control element includes a logo representing a function of a vehicle.

### BRIEF DESCRIPTION OF THE DRAWINGS

The invention will be better understood, thanks to the following description, which relates to several embodiments according to the present invention, given by way of non-limiting examples and explained with reference to the appended schematic drawings, in which:

FIG. 1 is a representation of a passenger compartment of an automobile according to a first embodiment of the invention;

FIG. 2 is a flowchart of a method according to the first embodiment.

### DETAILED DESCRIPTION

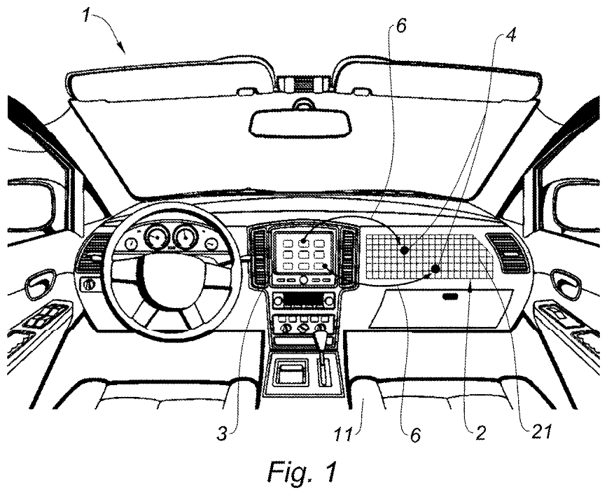

FIG. 1 shows a passenger compartment 1 of an automobile comprising a fastening area 2 in electronic connection with a control unit 3.

The fastening area 2 is a trim panel positioned facing the front passenger seat 11. Thus, the fastening area 2 is easily accessible to a passenger sitting next to the driver. The fastening area 2 comprises a capacitive film 21 forming a meshing. For the sake of clarity, in FIG. 1, the capacitive film 21 is disposed on a face of the trim panel, said face being visible by an occupant of the vehicle. The capacitive film 21 could be positioned on an inner face of the trim panel so as to be invisible to the occupants of the vehicle. Two control elements 4 are placed on said fastening area.

The control elements 4 may be repositionable adhesive pads with a logo representing a function of the vehicle.

The electronic connection between a control element 4 and the control unit is schematized by an arrow 6.

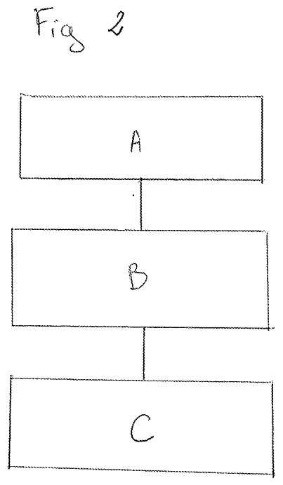

According to a first embodiment, the method for customizing a control element 4 is carried out in the following manner, as illustrated in FIG. 2:

A fastening step A during which:
The occupant selects a control element 4 in the form of a repositionable pad, one face of which can be printed with a logo representing a function of the vehicle that is desired to be positioned,
On a control unit 3 of the vehicle, the occupant selects a menu allowing to create a new control element 4;
The menu asks to position the pad on the fastening area 2;
The occupant attaches the pad at the desired location on the fastening area 2;
The occupant indicates on the control unit 3 that the pad is placed,

A definition step B during which:
The menu asks the occupant to designate the location of the pad on the fastening area 2;
The occupant then positions his finger on the pad;
The menu indicates that the pad has been identified;
The menu asks to select the vehicle function to associate with this pad;
The occupant selects the desired vehicle function,

The pad is then identified; that is to say it is paired with a vehicle function. The user can activate the vehicle function paired with the pad by putting his finger in contact with the pad. The occupant can also deactivate said function in the same manner.

The occupant can decide to modify the function associated with a control element 4.

The occupant may also decide to reposition the control element by carrying out the repositioning step C during which:
the occupant selects a menu on the control unit 3 allowing to reposition a control element 4;
the menu indicates to designate the pad to be repositioned,
the occupant positions his finger on the pad be repositioned,
the menu asks to select between displacing the pad or removing said pad;
if the occupant selects displacing the pad, then the occupant performs the following actions:
The menu asks to reposition the pad on the fastening area 2;
The occupant reattaches the pad at the desired location on the fastening area 2;
The occupant indicates on the control unit 3 that the pad is replaced;
The menu asks the occupant to designate the new location of the pad on the fastening area 2;
The occupant then positions his finger on the pad;
The menu indicates that the pad is repositioned

If the occupant selects to eliminate the pad, then, the occupant performs the following actions:
The menu indicates that the pad can be removed,
The occupant removes said pad.

The occupant can place several pads on the fastening area 2.

Of course, the invention is not limited to the embodiments described and shown in the appended figures. Modifications remain possible, in particular from the point of view of the constitution of the various elements or by the substitution of technical equivalents, without departing from the scope of protection of the invention.

1. A method for customizing a passive control element of a vehicle function, wherein the method implements:
a step of non-permanently fastening a passive control element in an active fastening area of said vehicle, in electronic connection with a control unit; and
a step of defining a function associated with the control element.

2. The method for customizing a passive control element of a vehicle function according to claim 1, including a step of modifying the function associated with the passive control element.

3. The method for customizing a passive control element of a vehicle function according to claim 1, including a step of repositioning said passive control element.

4. A device allowing the implementation of a method for customizing a passive control element of a vehicle function according to claim 1, the device comprising at least one control unit and at least one passive control element, wherein the device further comprises at least one active fastening area in electronic connection with the at least one control unit.

5. The device according to claim 4, wherein the at least one active fastening area comprises a printed capacitive film.

6. The device according to claim 5, wherein the capacitive film is disposed on a face of a trim panel.

7. The device according to claim 6, wherein the capacitive film is positioned by overmolding on the trim panel.

8. The device according to claim 4, wherein the at least one control element is repositionable.

9. The device according to claim 5, wherein the at least one control element is repositionable.

10. The device according to claim 6, wherein the at least one control element is repositionable.

11. The device according to claim 7, wherein the at least one control element is repositionable.

12. The method for customizing a passive control element of a vehicle function according to claim 2, including a step of repositioning said passive control element.

13. The device as in claim 4, wherein the method includes a step of modifying the function associated with the passive control element.

14. The device as in claim 4, wherein the method includes a step of repositioning said passive control element.

15. The device as in claim 13, wherein the method includes a step of repositioning said passive control element.

16. The device according to claim 15, wherein the at least one active fastening area comprises a printed capacitive film.

17. The device according to claim 16, wherein the capacitive film is disposed on a face of a trim panel.

18. The device according to claim 17, wherein the capacitive film is positioned by overmolding on the trim panel.

19. The device according to claim 18, wherein the at least one control element is repositionable.
